(19) United States
(12) Patent Application Publication
(10) Pub. No.: US 2026/0146915 A1
(43) Pub. Date: May 28, 2026

(54) HEALTH EVALUATION METHOD FOR TRAIN BEARING

(71) Applicant: Aktiebolaget SKF, Goteborg (SE)

(72) Inventors: Jinshu CUI, Shanghai (CN); Kaihuan ZHANG, Hangzhou (CN)

(73) Assignee: Aktiebolaget SKF, Goteborg (SE)

(21) Appl. No.: 19/392,319

(22) Filed: Nov. 18, 2025

(30) Foreign Application Priority Data
Nov. 22, 2024 (CN) 202411686214.9

(51) Int. Cl. G01M 13/04; B61K 9/04; G01K 13/08

(52) U.S. Cl. CPC G01M 13/04; B61K 9/04; G01K 13/08

(57) ABSTRACT

This disclosure provide a health evaluation method for train bearings. The method includes obtaining a bearing temperature data set collected from a plurality of bearings of the train during a trip and ambient temperature data set around the train during the trip. The method also includes performing feature extraction on the bearing temperature data set to generate a first set of temperature features and calculating a difference between each of the bearing temperature data set and corresponding ambient temperature data of the ambient temperature data set to generate a first set of temperature difference values. The method also includes performing the feature extraction on the first set of temperature difference values to generate a second set of temperature features. The method also includes generating an evaluation result of the health state of each bearing based on at least one of the first or second sets of temperature features.

### CROSS-REFERENCE TO RELATED APPLICATION

This application is based on and claims priority to Chinese Patent Application No. 202411686214.9, filed on Nov. 22, 2024 in the Chinese Patent Office, the entirety of which is hereby incorporated by reference.

### FIELD

The present disclosure relates to mechanical equipment, and in particular to health evaluation methods for train bearings.

### BACKGROUND

Bearings are important components in mechanical equipment. The bearing can support the rotating shaft, and when other components move relative to each other on the rotating shaft, the bearing can be used to maintain the center position of the shaft, thereby supporting the rotating body, reducing friction during its movement, and ensuring its rotation accuracy. Generally, bearings include components such as inner rings, outer rings, rolling elements, and cages.

The bearings of the train are generally located in the middle of the wheels on both sides of the train and are used to support the axles. Their main function is to support the mechanical rotating body and reduce the friction coefficient during movement. By using bearings, the train can travel more smoothly and efficiently. As the train continues to drive, the train bearings may experience defects such as aging and wear. The health status of the bearing can be evaluated using vibration data of the bearing, etc. However, the accuracy of evaluation methods that rely solely on vibration can be problematic.

Therefore, a method that can accurately evaluate the health status of train bearings is desired.

### SUMMARY

Embodiments of the disclosure provide a health evaluation method for train bearings, comprising: obtaining a bearing temperature data set collected from a plurality of bearings of the train during a trip of the train and ambient temperature data set around the train during the trip of the train; performing feature extraction on the bearing temperature data set to generate a first set of temperature features; calculating a difference between each of the bearing temperature data set and corresponding ambient temperature data of the ambient temperature data set to generate a first set of temperature difference values, performing the feature extraction on the first set of temperature difference values to generate a second set of temperature features; and generating an evaluation result of the health state of each of the plurality of bearings based on at least one of the first set of temperature features and the second set of temperature features.

The method according to at least one embodiment of the present disclosure, wherein the plurality of bearings are distributed on both sides of the train, wherein the method further comprises: calculating a one-side average temperature data set for a bearing of the plurality of bearings located on one side of a carriage of the train; calculating, based on the respective bearing temperature data set for each bearing of the plurality of bearings and the set of one-side average temperature data corresponding to the each bearing, a second set of temperature difference values, performing the feature extraction on the second set of temperature difference values to generate a third set of temperature features; and generating the evaluation result of the health state of each of the plurality of bearings based on at least one of the first temperature feature set, second temperature feature set, and third temperature feature set.

The method according to at least one embodiment of the present disclosure, wherein the feature extraction comprises extracting one or more of: maximum value, average value, change value, rate of change, peak-to-peak value, rate of change between peak-to-peak values, change slope, and peak-to-peak slope.

The method according to at least one embodiment of the present disclosure, further comprising: sampling the bearing temperature data set and the ambient temperature data set at a predetermined time interval to obtain a sampled bearing temperature data set and a sampled ambient temperature data set, wherein the first temperature feature set, the second temperature feature set, and the third temperature feature set are generated based on the sampled bearing temperature data set and the sampled ambient temperature data set.

The method according to at least one embodiment of the present disclosure, further comprising: obtaining operational bearing temperature data set and operational ambient temperature data set of bearing temperature data set and ambient temperature data set during operational periods in a trip of the train, wherein the first temperature feature set, the second temperature feature set, and the third temperature feature set are generated based on the operational bearing temperature data set and the operational ambient temperature data set.

The method according to at least one embodiment of the present disclosure, further comprising obtaining operational speed data and operational time data of the train during the operational period, and extracting, based on the speed data and the time data: an operating time, an accumulated operating range, an accumulated energy spent in operation, and a maximum speed of the train for a single operating period in the trip, or an accumulated operating time, operating mileage, energy spent in operation, and maximum speed of the train over the trip.

The method according to at least one embodiment of the present disclosure, generating the evaluation result of the health state of each of the plurality of bearings further comprising: establishing a health state evaluation machine learning model for one or more of the first temperature feature set, the second temperature feature set, and the third temperature feature set, generating, using the health state evaluation machine learning model, the evaluation result of the health state.

The method according to at least one embodiment of the present disclosure, further comprising: receiving one or more of weather, season, miles driven, road conditions, train maintenance information, accumulated operating time, horizontal load, determining a root cause of the change in the health state based on the first set of temperature features, the second set of temperature features, and the third set of temperature features and one or more of weather, season, mileage driven, road condition, train maintenance information, accumulated operating time, horizontal load.

The method according to at least one embodiment of the present disclosure, further comprising: performing a correlation analysis on the plurality of bearings based on one or more of the first set of temperature features, the second set of temperature features, and the third set of temperature features, determining, based on the results of the correlation analysis, two or more bearings with high correlation among the plurality of bearings.

The method according to at least one embodiment of the present disclosure, further comprising: establishing a health state evaluation machine learning model for results of the correlation analysis, generating, using the health state evaluation machine learning model, the evaluation result of the health state

According to an embodiment of the disclosure, there is provided a health evaluation device for a bearing of a train, comprising: a temperature obtaining module configured to obtain a bearing temperature data set collected from a plurality of bearings of a train during a trip of the train and a ambient temperature data set around the train during the trip of the train; a feature extraction module configured to perform feature extraction on the bearing temperature data set to generate a first set of temperature features; calculating a difference between each bearing temperature data of the bearing temperature data set and corresponding ambient temperature data of the ambient temperature data set to generate a first set of temperature difference values, performing the feature extraction on the first set of temperature difference values to generate a second set of temperature features; and a bearing health evaluation module configured to generate an evaluation result of the health state of each of the plurality of bearings based on at least one of the first set of temperature features and the second set of temperature features.

According to an embodiment of the present disclosure, a train is provided, including the above-mentioned non-transitory computer-readable storage medium and a health evaluation device for train bearings.

According to the health evaluation method for train bearings, non-transitory computer-readable storage medium, device and train according to embodiments of the present disclosure, the health evaluation of the train bearings can be performed based on the temperature data of the train bearings, thereby reducing unexpected failures or reducing maintenance costs. In addition, the method can also discover the root cause of the change in bearing health.

### BRIEF DESCRIPTION OF DRAWINGS

The above and other aspects, features and advantages of specific embodiments of the present disclosure will become more apparent from the following description taken in conjunction with the accompanying drawings, in which:

FIG. 1 is a flow chart of a health evaluation method for train bearings according to an embodiment of the present disclosure.

FIG. 2 is a flow chart of another health evaluation method for train bearings according to an embodiment of the present disclosure.

FIG. 3 is a schematic diagram of the data flow of a health evaluation method for a train bearing according to an embodiment of the present disclosure.

FIG. 4A shows a graph of bearing temperature, ambient temperature, and train speed in accordance with an embodiment of the present disclosure.

FIG. 4B shows a graph of dividing bearing temperature data and ambient temperature data according to operating periods of the train during a trip of the train, in accordance with embodiments of the present disclosure.

FIG. 5 is a schematic diagram of a health evaluation device 500 for a train bearing in accordance with at least one embodiment of the present disclosure.

FIG. 6 is a non-transitory computer-readable storage medium in accordance with at least one embodiment of the present disclosure.

### DETAILED DESCRIPTION

Before proceeding to the following detailed description, it may be beneficial to set forth the definitions of certain words and phrases used throughout this patent application document. The terms “including” and “containing” and their derivatives refer to including but not limited to. The term “controller” or “control unit” refers to any device, system or part thereof that controls at least one operation. Such a controller may be implemented in hardware or a combination of hardware and software and/or firmware. The functions associated with any particular controller can be centralized or distributed, whether local or remote. The phrase “at least one”, when used with a list of items, means that different combinations of one or more of the listed items can be used, and only one item in the list may be needed. For example, “at least one of a, b and c” includes any one of the following combinations: a, b, c, a and b, a and c, b and c, a and b and c.

Definitions of other specific words and phrases are provided throughout this patent application document. It should be understood by those skilled in the art that in many cases, if not most cases, this definition also applies to the previous and future uses of words and phrases so defined.

The following description of various embodiments of the principles of the present disclosure in this patent application document with reference to the accompanying drawings is for illustration only and should not be interpreted as limiting the scope of the present disclosure in any way. Those skilled in the art will understand that the principles of the present disclosure can be implemented in any suitably arranged system or device. In some cases, the actions described in the specification can be performed in a different order and still achieve the desired results. Moreover, the processes depicted in the drawings do not necessarily require the specific order shown or sequential order to achieve the desired results. In certain embodiments, multitasking and parallel processing may be advantageous.

Existing train bearing health evaluation methods are generally based on vibration data. However, the results obtained by merely evaluating the health of the train bearings based on vibration data may be incomplete.

In addition, existing methods generally only analyze the health status of the train bearings, but cannot obtain the root cause of the change in the health status of the train bearings. Such evaluation results may pose challenges for maintenance operations of train bearings.

Therefore, a method for evaluating the health status of the train bearing in combination with the temperature data of the train bearing is desired, and the root cause of the change in the health status of the train bearing is expected.

The present disclosure provides a health evaluation method for bearings of a train, comprising: obtaining a bearing temperature data set collected from a plurality of bearings of the train during a trip of the train and a ambient temperature data set around the train during the trip of the train; performing feature extraction on the bearing temperature data set to generate a first set of temperature features; calculating a difference of each bearing temperature data of the bearing temperature data set and corresponding ambient temperature data of the ambient temperature data set to generate a first set of temperature difference values, performing feature extraction on the first set of temperature difference values to generate a second set of temperature features; and generating an evaluation of the health of each of the plurality of bearings based on at least one of the first set of temperature features and the second set of temperature features. Furthermore, by combining the results of the temperature-based train bearing health status evaluation with additional data, the root cause of the change in train bearing health status can be analyzed to provide guidance and recommendations to train maintenance personnel on their maintenance work. Methods according to embodiments of the present disclosure can, after completing the root cause analysis of the generation of temperature anomalies (e.g., high temperatures), improve the bearing design and lubrication scheme based on the results of the analysis, thereby avoiding subsequent recurrence of this type of abnormally high temperatures.

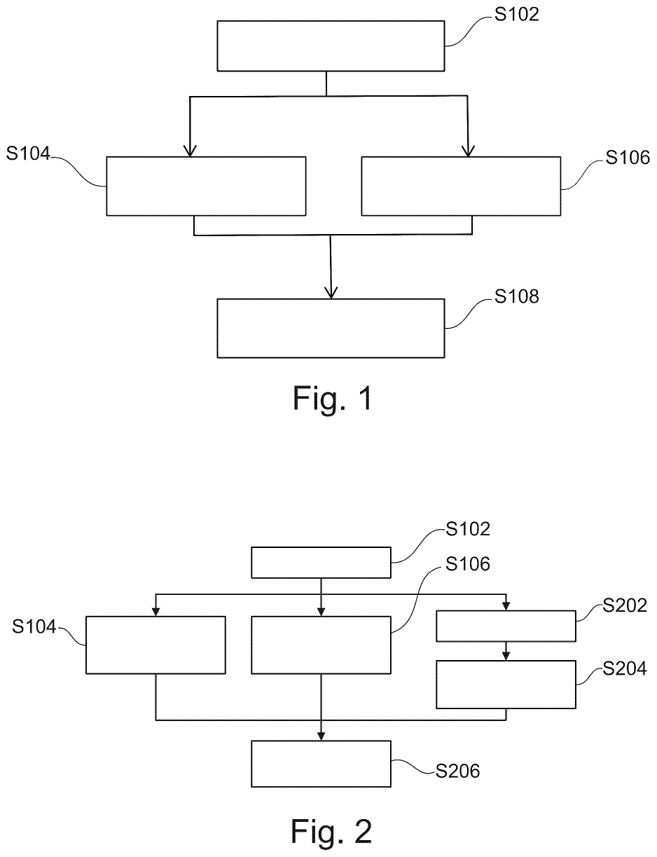

FIG. 1 is a flow chart of a health evaluation method for train bearings according to an embodiment of the present disclosure.

As shown in FIG. 1, the health evaluation method for train bearings may include steps S102, S104 and S106.

At step S102, a bearing temperature data set collected from a plurality of bearings of the train during the trip of the train and a ambient temperature data set around the train during the trip of the train may be obtained. According to one embodiment of the present disclosure, temperature data of the bearings may be collected from a plurality of bearings of the train using temperature sensors. The temperature sensors may include, but are not limited to, contact temperature sensors (such as bimetal thermometers, liquid-in-glass thermometers, pressure thermometers, resistance thermometers, thermistors, thermocouples, etc.) and non-contact temperature sensors (such as various non-contact temperature sensors based on radiation thermometry including luminance, radiation, and colorimetric methods). According to one embodiment of the present disclosure, the temperature sensor may be installed near the bearing of the train, for example, near the outer ring or the inner ring of the bearing. According to one embodiment of the present disclosure, ambient temperature data around the train during a trip of the train may be obtained using a temperature sensor. The temperature sensor from which the ambient temperature data is obtained may be one or more of the temperature sensors described above. Furthermore, according to another embodiment of the present disclosure, ambient temperature data may be obtained from a network based on positioning information and weather reports. For example, positioning information of the train may be obtained based on signals such as Global Positioning System signals or BeiDou signals, and weather reports may be retrieved based on the positioning information to obtain ambient temperature data.

At step S104, feature extraction may be performed on the bearing temperature data set to generate a first temperature feature set. According to one embodiment of the present disclosure, one or more feature extractions may be performed on the bearing temperature data set. One or more feature extractions may include extracting the maximum value, average value, change value, change rate, peak-to-peak value, change rate between peak-to-peak value, change slope, and peak-to-peak slope, etc. of the bearing temperature data set. For example, the bearing temperature data set may include 1,000 temperature data arranged in order of acquisition time. The change value may refer to the temperature difference between the last collected temperature data and the first collected temperature data among the 1000 temperature data. The rate of change may refer to the temperature difference divided by the acquisition time difference between the last acquired temperature data and the first acquired temperature data. The change slope may refer to the slope of the temperature value relative to time between the last collected temperature data and the first collected temperature data in the temperature data set, obtained through techniques such as fitting.

The peak-to-peak value can refer to the temperature difference between the maximum temperature value and the minimum temperature value among the 1000 temperature data. The rate of change between peak-to-peak values may refer to the peak-to-peak value divided by the acquisition time difference between the maximum temperature value and the minimum temperature value. The peak-to-peak slope may refer to the slope of the temperature value between the maximum temperature value and the minimum temperature value in the temperature data set with respect to time, obtained through techniques such as fitting.

At step S106, the difference between each bearing temperature data in the bearing temperature data set and the corresponding ambient temperature data in the ambient temperature data set may be calculated to generate a first temperature difference set, and feature extraction may be performed on the first temperature difference set to generate a second temperature feature set. According to an embodiment of the present disclosure, the bearing temperature in the bearing temperature data set may be subtracted from the ambient temperature in the corresponding ambient temperature data set, thereby obtaining a first temperature difference set. One or more of the feature extractions described above including maximum value, average value, change value, rate of change, peak-to-peak value, rate of change between peak-to-peak values, slope of change, and slope of peak-to-peak value, etc. may be performed on the first set of temperature difference values to obtain a second set of temperature features.

At step S108, an evaluation result of the health status of each bearing of the plurality of bearings may be generated based on at least one of the first temperature feature set and the second temperature feature set. According to one embodiment of the present disclosure, a machine learning model may be established to process at least one of the first temperature feature set and the second temperature feature set to generate an evaluation result of the health status of the train bearing. Furthermore, corresponding threshold values may be determined to be compared with the first temperature feature set and the second temperature feature set respectively to generate an evaluation of the health status of the train bearing. The result of the evaluation of the state of health of the train bearing may include one or more of a diagnosis of a fault, a prediction of a fault, and a prediction of a remaining life of the bearing, but the present disclosure is not limited thereto.

FIG. 2 is a flow chart of another health evaluation method for train bearings according to an embodiment of the present disclosure.

As shown in FIG. 2, the health evaluation method for a train bearing may include steps S102, S104, and S106 and steps S202, S204, and S206. The specific contents of steps S102, S104, and S106 are similar to the response steps in FIG. 1, and will not be repeated here.

At step S202, a single-sided average temperature data set of a bearing located on one side of the train carriage among the plurality of bearings may be calculated. For example, each train may correspond to a plurality of carriages, and each carriage may correspond to a plurality of bogies, each bogie may correspond to a plurality of axles, and each axle may correspond to a plurality of bearings. According to one embodiment of the present disclosure, a train may include 16 carriages, each carriage may include 2 bogies, each bogie may include 2 axles, and each axle may include 2 bearings distributed on both sides of the train car. Those skilled in the art can understand that the above quantitative correspondences of trains, carriages, bogies, axles, and bearings are exemplary and non-limiting, and other quantitative correspondences are also possible depending on the train manufacturer. According to the above-described embodiment of the present disclosure, 4 bearings may be distributed on one side of the carriage of the train. Based on the corresponding bearing temperature data, a single-sided average temperature of the bearing on the side of the train carriage may be calculated.

At step S204, a second temperature difference set may be calculated based on the corresponding bearing temperature data set of each bearing in the plurality of bearings and the single-sided average temperature data set corresponding to each bearing, and feature extraction may be performed on the second temperature difference set to generate a third temperature feature set. According to an embodiment of the present disclosure, the single-sided average temperature corresponding to each bearing in the single-sided average temperature data set can be subtracted from the bearing temperature in the bearing temperature data set to obtain a second temperature difference set. One or more of the feature extractions described above including maximum value, average value, change value, rate of change, peak-to-peak value, and rate of change between peak-to-peak values, slope of change, and slope of peak-to-peak value, etc. may be performed on the second set of temperature difference values to obtain a third set of temperature features.

At step S206, an evaluation result of the health status of each bearing of the plurality of bearings may be generated based on at least one of the first temperature feature set, the second temperature feature set, and the third temperature feature set. According to an embodiment of the present disclosure, a machine learning model may be established to process at least one of the first temperature feature set, the second temperature feature set and the third temperature feature set to generate an evaluation result of the health status of the train bearing. Machine learning models may include, but are not limited to, statistical models, distribution-based machine learning models, distance-based machine learning models, density-based machine learning models, connection-based anomaly factors, random anomaly selection, clustering-based machine learning models, tree-based machine learning models, dimensionality reduction-based machine learning models, autoencoders, classification-based machine learning models, prediction-based machine learning models, but the present disclosure is not limited thereto. In some examples, the machine learning model may use supervised learning. In some examples, the machine learning model uses unsupervised learning. Furthermore, corresponding threshold values may be determined to be compared with the first temperature feature set, the second temperature feature set and the third temperature feature set respectively to generate an evaluation of the health status of the train bearing.

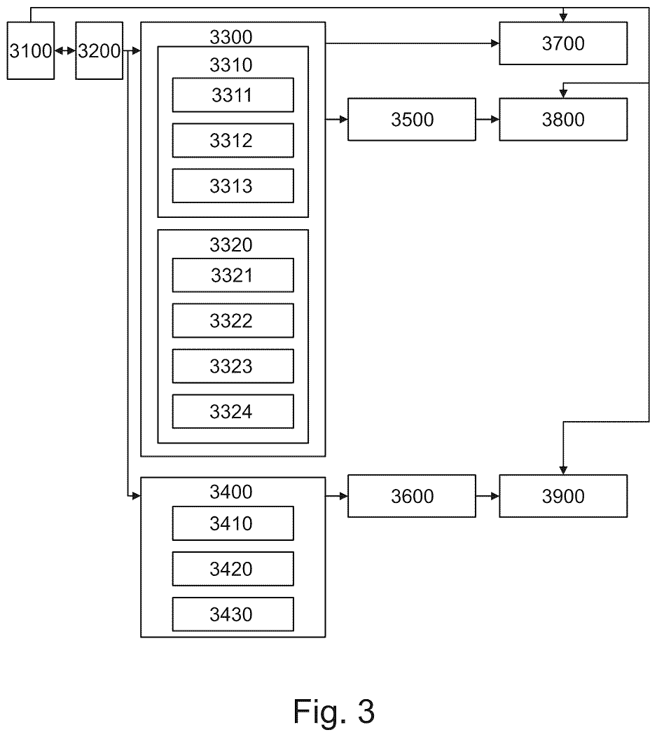

FIG. 3 is a schematic diagram of the data flow of a health evaluation method for a train bearing according to an embodiment of the present disclosure.

At block 3100, raw data may be obtained from a train operating agency, such as a railway administration, and the raw data may be preprocessed. The raw data may include raw data of vehicle bearing temperature data set, ambient temperature data set, vehicle structural data, vehicle operating parameters, root cause related parameters 3001, but the raw data may include more data. According to one embodiment of the present disclosure, the vehicle bearing temperature data set and the ambient temperature data set may include data on multiple vehicle bearing temperatures, multiple ambient temperatures, corresponding times, and the like. Vehicle structure data may include parameters regarding the train's carriages, bogies, axles, bearing number relationships, etc. The vehicle operation parameter may comprise data on the speed of the train and the corresponding time. The root cause related parameters may comprise one or more of weather, season, mileage driven, road condition, train maintenance information, accumulated operating time, horizontal load. Weather and seasons can be retrieved through the network. Trip mileage can indicate the cumulative mileage traveled by the train. The road conditions may indicate various road conditions corresponding to the route traveled by the train, such as gradients, turns, etc. The train maintenance information may indicate, among other things, maintenance that the train has performed on (e.g., maintenance on train bearings). The accumulated operating time can indicate the accumulated time a train travels after being put into service. The horizontal load may indicate a horizontal load experienced by the train when the train is turning, for example, a horizontal load directed to both sides of the train. The raw data can be pre-processed into a data format corresponding to a designated train manufacturer or train operating agency for subsequent analysis.

At block 3200, data related to a specific bearing of the plurality of bearings may be obtained from the raw data for subsequent analysis. For example, temperature data related to a specific axial direction, carriage number, bogie number, axle number, bearing number, ambient temperature, vehicle operating parameters, etc. can be extracted.

At block 3300, feature extraction may be performed on data obtain relating to a particular bearing of a plurality of bearings. Feature extraction may be performed from two aspects, which will be described below with reference to blocks 3310 and 3320.

At block 3310, feature extraction may be performed on the data related to the specific bearing based on predetermined intervals. For example, the bearing temperature data set and the ambient temperature data set may be acquired at very short time intervals, e.g. a few milliseconds or seconds, or longer or shorter. That is, the bearing temperature data and the ambient temperature data may be time intensive. According to one embodiment of the present disclosure, the bearing temperature data set and the ambient temperature data set may be sampled at predetermined time intervals (e.g., several minutes, tens of minutes, or longer or shorter) to obtain the sampled bearing temperature data set and the sampled ambient temperature data set. As shown in blocks 3311 to 3313, the feature extraction described with reference to FIGS. 1 and 2 may be performed on the sampled temperature data and the sampled ambient temperature data to obtain a first temperature feature set, a second temperature feature set, and a third temperature feature set.

At block 3320, feature extraction may be performed on the data related to the specific bearing based on the operating period of the train in the trip of the train. During the entire trip of the train from the starting point to the ending point, there may be operating periods and stopping periods. The operating period of the train may correspond to a period during which the train is in a traveling state, during which the traveling speed of the train may be greater than a predetermined speed threshold. During the stop period, the train can be in a stopped state, for example, the train can be stopped in a station. According to one embodiment of the present disclosure, among the bearing temperature data set and the ambient temperature data set, an operating bearing temperature data set and an operating ambient temperature data set during an operating period in the trip of the train may be obtained. As shown in blocks 3321 to 3323, the feature extraction described with reference to FIGS. 1 and 2 may be performed on the operating bearing temperature data set and the operating ambient temperature data set to obtain the first temperature feature set, the second temperature feature set, and Third temperature feature set.

Furthermore, as shown in block 3324, according to one embodiment of the present disclosure, feature extraction may be performed on the data regarding the speed of the train and the corresponding time included in the vehicle operating parameters. For example, the following features may be extracted based on the speed data and time data: operating time, operating mileage, energy spent by the operation, and maximum speed for a single operating period during the trip of the train. A trip of a train may include a plurality of operating periods. For example, the trip of the train may correspond to a start-to-end trip, and the plurality of operating periods may correspond to operating periods between a plurality of stopped stops. For another example, the following features may be extracted based on the speed data and time data: accumulated operating time, accumulated operating mileage, accumulated energy spent operating, and maximum speed during the trip of the train.

At block 3370, an evaluation of the health of the train bearing may be generated based on at least one of the first temperature feature set, the second temperature feature set, and the third temperature feature set using the first machine learning model. According to an embodiment of the present disclosure, the first machine learning model may include, but is not limited to, a statistical model, a distribution-based machine learning model, a distance-based machine learning model, a density-based machine learning model, a connection-based anomaly factor, a random anomaly selection, clustering-based machine learning models, tree-based machine learning models, dimensionality reduction-based machine learning models, autoencoders, classification-based machine learning models, prediction-based machine learning models, but the present disclosure is not limited thereto. In some examples, the first machine learning model can use supervised learning. In some examples, the first machine learning model uses unsupervised learning. Furthermore, corresponding threshold values may be determined to be compared with the first temperature feature set, the second temperature feature set and the third temperature feature set respectively to generate an evaluation of the health status of the train bearing. Furthermore, the first machine learning model may receive root cause parameters to further analyze a root cause causing the change in bearing health based on the root cause parameters and at least one of the first, second and third temperature feature sets. In addition, the first machine learning model can, after completing the root cause analysis of the occurrence of temperature anomalies (for example, high temperatures), improve the bearing design and lubrication scheme based on the results of the analysis, thereby avoiding the subsequent recurrence of this type of abnormally high temperature.

At block 3350, correlation analysis may be performed on the first temperature feature set, the second temperature feature set, and the third temperature feature set to determine two or more bearings with higher correlation. The first temperature feature set, the second temperature feature set, and the third temperature feature set may be extracted according to a predetermined interval time or extracted according to an operating period. A machine learning model may be established to perform correlation analysis on the first temperature feature set, the second temperature feature set, and the third temperature feature set to determine two or more bearings with higher correlation. The machine learning model that performs correlation analysis may include a data association model, a decision tree, a random forest, a logistic regression, naive Bayes, or the like, but the present disclosure is not limited thereto. The results of the correlation analysis can be provided to the train bearing maintenance personnel to facilitate maintenance and cause analysis by the train bearing maintenance personnel.

At block 3380, a second machine learning model may be used to generate an evaluation of the state of health of the train bearing based on the results of the correlation analysis. According to an embodiment of the present disclosure, the type of second machine learning model may be similar to the type of the first machine learning model, and the description will not be repeated here. Furthermore, the second machine learning model may receive the root cause parameters to further analyze the root cause causing the bearing health change based on the results of the correlation analysis and the root cause parameters. In addition, the second machine learning model can, after completing the root cause analysis of the occurrence of temperature anomalies (for example, high temperatures), improve the bearing design and lubrication scheme based on the results of the analysis, thereby avoiding the subsequent recurrence of this type of abnormally high temperature.

In an example not shown, the first machine learning model and the second machine learning model may be merged into one and the same model to generate an evaluation of the health of the bearing of the train and determine a root cause leading to a change in the health of the bearing of the train based on the first temperature feature set, the second temperature feature set, the third temperature feature set, the result of the correlation analysis and the root cause parameter.

At block 3400, a bearing temperature data set, a first set of temperature difference values, and a second set of temperature difference values may be obtained. The process of obtaining the first set of temperature difference values and the second set of temperature difference values may be similar to that described in FIGS. 1 and 2, and the description will not be repeated here.

At block 3600, a correlation analysis may be performed directly on the bearing temperature data set, the first set of temperature difference values, and the second set of temperature difference values to determine two or more bearings with higher correlation. The bearing temperature, the first set of temperature differences and the second set of temperature differences may be calculated based on interval times or based on operating periods. A machine learning model may be established to perform a correlation analysis on the bearing temperatures, the first set of temperature differences, and the second set of temperature differences to determine two or more bearings with higher correlation. The machine learning model that performs correlation analysis may include a data association model, a decision tree, a random forest, a logistic regression, naive Bayes, or the like, but the present disclosure is not limited thereto. The results of the correlation analysis can be provided to the train bearing maintenance personnel to facilitate maintenance and cause analysis by the train bearing maintenance personnel.

At block 3900, a third machine learning model may be used to generate an evaluation of the state of health of the train bearing based on the results of the correlation analysis. According to an embodiment of the present disclosure, the third machine learning model may include a machine learning model type similar to the types of the first machine learning model and the second machine learning model, and the description will not be repeated here. Furthermore, the third machine learning model may receive the root cause parameters to further analyze the root cause causing the bearing health change based on the results of the correlation analysis and the root cause parameters. In addition, the third machine learning model can, after completing the root cause analysis of the occurrence of temperature anomalies (for example, high temperatures), improve the bearing design and lubrication scheme based on the results of the analysis, thereby avoiding the subsequent recurrence of this type of abnormally high temperature.

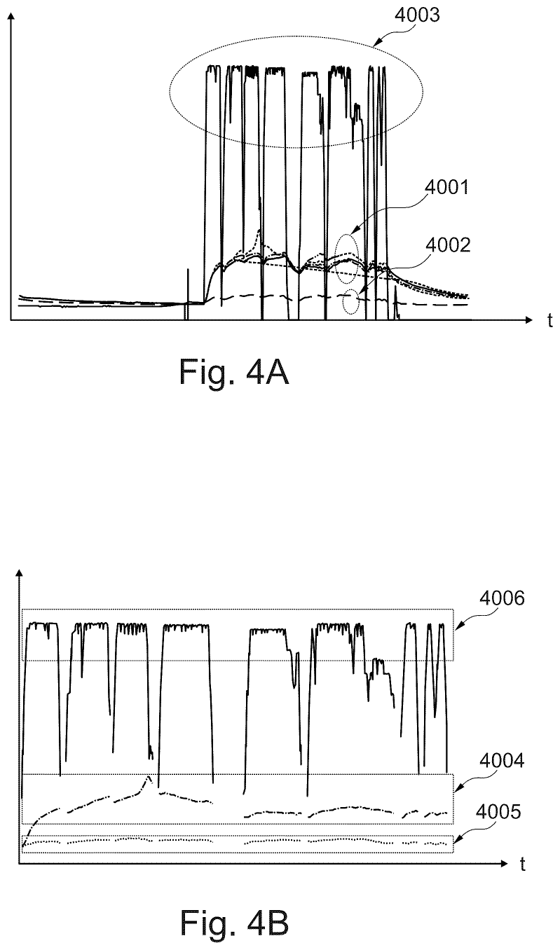

FIG. 4A shows a graph of a bearing temperature data set, an ambient temperature data set, and a train speed in accordance with an embodiment of the present disclosure. FIG. 4B shows a diagram of partitioning a bearing temperature data set and an ambient temperature data set according to an operating period of the train during a trip of the train, in accordance with an embodiment of the present disclosure.

As shown in FIG. 4A, a bearing temperature data set 4001 over time t and a ambient temperature data set 4002 and train speed data 4003 over time t can be obtained. The bearing temperature data set 4001 can be divided according to predetermined intervals or according to operating periods for feature extraction. As shown in FIG. 4B, the bearing temperature data set 4004 and the ambient temperature data set of one bearing 4005 may be divided according to the operating period of the train during the trip of the train (for example, according to the train speed 4006). FIG. 4B shows the bearing temperature set and the ambient temperature set of one bearing after removing the bearing temperature and the ambient temperature when the train is stopped in FIG. 4A.

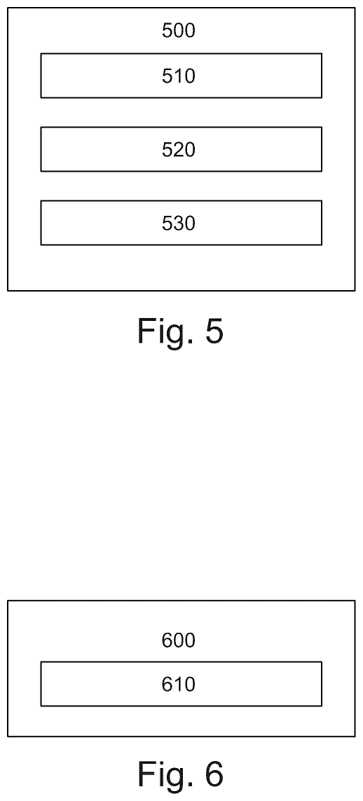

FIG. 5 is a schematic diagram of a health evaluation device 500 for a train bearing in accordance with at least one embodiment of the present disclosure.

As shown in FIG. 5, the health evaluation device 500 for a train bearing may include a temperature obtaining module 510, a feature extraction module 520, and a bearing health status evaluation module 530.

The temperature obtaining module 510 may be configured to obtain a bearing temperature data set collected from a plurality of bearings of the train during a trip of the train and a ambient temperature data set around the train during the trip of the train.

The feature extraction module 520 may be configured to perform feature extraction on the bearing temperature data set to generate a first temperature feature set; a difference of each bearing temperature data of the bearing temperature data set and corresponding ambient temperature data of the ambient temperature data set is calculated to generate a first set of temperature difference values, and feature extraction is performed on the first set of temperature difference values to generate a second set of temperature features.

The bearing health evaluation module 530 may be configured to generate an evaluation of the health of each of the plurality of bearings based on at least one of the first temperature feature set and the second temperature feature set.

FIG. 6 is a non-transitory computer-readable storage medium in accordance with at least one embodiment of the present disclosure.

As shown in FIG. 6, non-transitory computer-readable storage medium 600 has computer instructions 610 stored thereon that, when executed by a processor, perform one or more steps of the various methods and additional aspects thereof as described above.

For example, the non-transitory computer-readable storage medium 600 may be any combination of one or more computer-readable storage media. For example, a computer-readable storage medium contains program codes for executing the various methods described above.

Exemplarily, when the program code is read by a computer, the computer can execute the program code stored in the computer storage medium and execute it to implement, for example, one or more steps of the above various methods and additional aspects thereof according to at least one embodiment of the present disclosure.

Illustratively, the non-transitory computer-readable storage medium may include a memory card of a smart phone, a storage component of a tablet computer, a hard disk of a personal computer, a random access memory (RAM), a read-only memory (ROM), an erasable programmable read-only memory (EPROM), a portable compact disc read-only memory (CD-ROM), flash memory, and other non-transitory readable storage media, or any combination thereof.

According to this disclosed embodiment, a train is also provided. The train may include the aforementioned non-temporary computer-readable storage media and health evaluation equipment for train bearings.

According to the health evaluation method, non-transitory computer-readable storage medium, device and train for train bearings according to embodiments of the present disclosure, the health assessment of the train bearings may be performed based on the temperature data of the train bearings, thereby reducing unexpected failures or reducing maintenance costs. In addition, the method may also discover the root cause of the change in bearing health.

The text and drawings are provided as examples only to assist in understanding the present disclosure. They should not be construed as limiting the scope of the disclosure in any way. Although certain embodiments and examples have been provided, it will be apparent to those skilled in the art, based upon this disclosure, that changes can be made to the embodiments and examples shown without departing from the scope of the disclosure.

Although the present disclosure has been described with an exemplary embodiment, various changes and modifications may be suggested to one skilled in the art. It is intended that the present disclosure encompass such changes and modifications as fall within the scope of the appended claims.

None of the description in the present disclosure should be read as implying that any particular element, step, or function is an essential element that must be included in the claim scope. The scope of patented subject matter is defined only by the claims.

What is claimed is:

1. A health evaluation method for train bearings, the method comprising:
obtaining a bearing temperature data set collected from a plurality of bearings of the train during a trip of the train and ambient temperature data set around the train during the trip of the train;
performing feature extraction on the bearing temperature data set to generate a first set of temperature features;
calculating a difference between each bearing temperature data of the bearing temperature data set and corresponding ambient temperature data of the ambient temperature data set to generate a first set of temperature difference values, performing the feature extraction on the first set of temperature difference values to generate a second set of temperature features; and
generating an evaluation result of the health state of each of the plurality of bearings based on at least one of the first set of temperature features or the second set of temperature features.

2. The method of claim 1, wherein the plurality of bearings are distributed on both sides of the train, wherein the method further comprises:
calculating a one-side average temperature data set for a bearing of the plurality of bearings located on one side of a carriage of the train;
calculating, based on the respective bearing temperature data set for each bearing of the plurality of bearings and the set of one-side average temperature data corresponding to the each bearing, a second set of temperature difference values, performing the feature extraction on the second set of temperature difference values to generate a third set of temperature features; and
generating the evaluation result of the health state of each of the plurality of bearings based on at least one of the first temperature feature set, second temperature feature set, or third temperature feature set.

3. The method of claim 1, wherein the feature extraction comprises extracting one or more of: maximum value, average value, change value, rate of change, peak-to-peak value, rate of change between peak-to-peak values, change slope, and peak-to-peak slope.

4. The method of claim 2, further comprising:
sampling the bearing temperature data set and the ambient temperature data set at a predetermined time interval to obtain a sampled bearing temperature data set and a sampled ambient temperature data set;
wherein the first temperature feature set, the second temperature feature set, and the third temperature feature set are generated based on the sampled bearing temperature data set and the sampled ambient temperature data set.

5. The method of claim 2, further comprising:
obtaining operational bearing temperature data set and operational ambient temperature data set of bearing temperature data set and ambient temperature data set during operational periods in a trip of the train;
wherein the first temperature feature set, the second temperature feature set, and the third temperature feature set are generated based on the operational bearing temperature data set and the operational ambient temperature data set.

6. The method of claim 5, further comprising obtaining operational speed data and operational time data of the train during the operational period, and extracting, based on the speed data and the time data:
an operating time, an accumulated operating range, an accumulated energy spent in operation, and a maximum speed of the train for a single operating period in the trip; or
an accumulated operating time, operating mileage, energy spent in operation, and maximum speed of the train over the trip.

7. The method of claim 2, wherein said generating the evaluation result of the health state of each of the plurality of bearings further comprises:
establishing a health state evaluation machine learning model for one or more of the first temperature feature set, the second temperature feature set, and the third temperature feature set; and
generating, using the health state evaluation machine learning model, the evaluation result of the health state.

8. The method of claim 7, further comprising:
receiving one or more of weather, season, miles driven, road conditions, train maintenance information, accumulated operating time, horizontal load; and
determining a root cause of the change in the health state based on the first set of temperature features, the second set of temperature features, and the third set of temperature features and one or more of weather, season, mileage driven, road condition, train maintenance information, accumulated operating time, horizontal load.

9. The method of claim 2, further comprising:
performing a correlation analysis on the plurality of bearings based on one or more of the first set of temperature features, the second set of temperature features, and the third set of temperature features; and
determining, based on the results of the correlation analysis, two or more bearings with high correlation among the plurality of bearings.

10. The method of claim 9, further comprising:
establishing a health state evaluation machine learning model for results of the correlation analysis; and
generating, using the health state evaluation machine learning model, the evaluation result of the health state.
